(19) United States
(12) Patent Application Publication
(10) Pub. No.: US 2011/0204161 A1
(43) Pub. Date: Aug. 25, 2011

(54) DOOR WITH MOVABLE SPOILER FOR DOOR-TYPE THRUST REVERSER

(75) Inventor: Alain D'inca, Briis s/s Forges (FR)

(73) Assignee: AIRCELLE, Gonfreville L' Orcher (FR)

(21) Appl. No.: 12/600,075

(22) PCT Filed: Mar. 28, 2008
(86) PCT No.: PCT/FR08/00432

§ 371 Date: Nov. 13, 2009

(30) Foreign Application Priority Data
May 21, 2007 (FR) 0703576

(51) Int. Cl. F02K 1/56

(52) U.S. Cl. 239/265.27

(57) ABSTRACT

The present invention relates to a door (9) for a door-type thrust reverser able to be hinged to a fixed structure of a thrust reverser comprising an internal surface designed to integrate with a stream of an airflow generated by a turbojet and an outer surface designed to provide the external aerodynamic continuity of a nacelle to which said thrust reverser is to be fitted, said door being fitted with airflow deflection means located at an upstream end of the door and mounted movably in a plane approximately perpendicular to the plane of the door between a first, retracted position in which the deflection means do not enter the stream when the door is closed and a second, deployed position in which the deflection means project from the door, said door being characterized in that the deflection means are rotatable in the said plane about a corresponding shaft.

### TECHNICAL FIELD

The disclosure relates to a door for a door thrust reverser and to such a thrust reverser and to a nacelle fitted with such a thrust reverser.

### BRIEF DESCRIPTION OF BACKGROUND

The role of a thrust reverser during the landing of an airplane is to improve the braking capacity of an airplane by redirecting forward at least a portion of the thrust generated by the turbojet. In this phase, the reverser obstructs the gas exhaust nozzle and directs the exhaust flow from the motor toward the front of the nacelle, thereby generating a counter-thrust which is added to the braking action of the airplane wheels.

The means used to achieve this reorientation of the flow vary depending upon the type of reverser. However, in all cases, the structure of a reverser comprises movable cowls that can be moved between, on the one hand, a deployed position in which they open in the nacelle a passageway designed for the diverted flow, and, on the other hand, a retracted position in which they close this passageway. These movable cowls may also fulfill a function of diversion or simply of activation of other diversion means.

In cascade-vane reversers, for example, the movable cowls slide along rails so that, when retracting during the opening phase, they expose deflection cascade vanes placed in the thickness of the nacelle. A system of link rods connects this movable cowl to locking doors which deploy inside the exhaust channel and block the direct-flow outlet. In door reversers, on the other hand, each movable cowl pivots so as to block the flow and deflect it and is therefore active in this reorientation.

More precisely, a door thrust-reversal device comprises one or more doors mounted so as to pivot so that they can, under the action of driving means, tilt between an inactive position called the closed position during operation of the turbojet called direct jet operation in which the doors form a portion of the downstream section, and a reversal position or open position in which they tilt in such a way that a downstream portion of each door at least partially obstructs the duct of the nacelle and an upstream portion opens in the downstream section a passageway allowing the air flow to be channeled radially relative to a longitudinal axis of the nacelle.

The pivot angle of the doors is adjusted so as to greatly reduce and even eliminate the thrust force generated by the flow being exhausted in a direct jet and does so up to the point of possibly generating a counter-thrust by generating a flow component that is deflected in the upstream direction of the nacelle.

For a general description of door thrust reversers it is possible to refer to documents FR 1 482 538, FR 2 030 034 or else U.S. Pat. No. 3,605,411.

In order to be able to improve the reorientation of the air flow in a direction tending as close as possible to a longitudinal direction of the nacelle, the doors have been fitted with terminal spoilers, also called deflectors, forming upstream of the door a return substantially perpendicular to the latter. Therefore, when the door is in the thrust-reversal position, the spoiler is oriented in a substantially longitudinal direction of the nacelle and forces the air flow in this direction.

Reciprocally, when the door is in the closed position, each spoiler is oriented in a direction substantially perpendicular to the longitudinal axis of the nacelle and enters the air-flow duct. The spoiler then risks blocking the air flow traveling in a direct jet, which is not admissible.

In order to alleviate this drawback, the doors have been designed so as to have an upstream cavity on an internal surface of said door.

Accordingly, the door has a reduced thickness upstream which allows both the spoiler to protrude from said door and not to have a length greater than the thickness of the nacelle upstream of the door so as not to enter the air-flow duct when the door is in the closed position.

A general structure of a reverser door is shown in FIGS. 1 and 2 in closed and open positions respectively.

It should however be noted that such a cavity forms a considerable aerodynamic irregularity inside the air-flow duct when the door is in the closed position, which reduces the general performance of the turbojet.

Various solutions have been used to try to reduce the depth of this cavity, and even to eliminate it, during direct jet operation by movable panels capable of moving away from it during a thrust-reversal operation. However, such solutions require complex articulation systems and increase the number of movable elements that must articulate together.

Consequently, there is a need for solutions making it possible to maintain doors that perfectly ensure the aerodynamic continuity of the interior of the air-flow duct.

One solution provided for this problem is to fit the doors with retractable spoilers. Such a solution is described in documents U.S. Pat. No. 6,293,495 and EP 0 301 939 for example.

However, the systems currently used remain complicated, using complex and/or fragile guidance and articulation means, and there is a need for a simple and reliable system.

### BRIEF DESCRIPTION OF THE DISCLOSURE

A door is provided for a door thrust reverser capable of being mounted so as to pivot on a fixed structure of a thrust reverser comprising an internal surface designed to be incorporated into a flow duct for an air flow generated by a turbojet and an external surface designed to ensure the external aerodynamic continuity of a nacelle designed to be fitted with said thrust reverser, said door being fitted with air-flow deflection means placed on an upstream end of the door and mounted so that they can move in a plane substantially perpendicular to the plane of the door between a first retracted position in which the deflection means do not enter the duct when the door is in the closed position and a second deployed position in which the deflection means protrude from the door, characterized in that the deflection means are mounted so that they can rotate in said plane about a corresponding shaft.

Therefore, equipping the movable flaps with rotational articulation systems constitutes a light and strong articulation means. Moreover, a system of articulation by pivoting makes it possible to optimize the movable spoiler function because it allows, on the one hand, a better retraction making possible up to the elimination of the door cavity and the optimum aerodynamic integration of said door into the air-flow duct, and, on the other hand, a better deployment because the articulation means of such a flap are limited and particularly space-saving on the upstream surface of the door in which the flap is attached. It is the result of a larger flap than those of the prior art.

Advantageously, the deflection means are mounted so that they can move against elastic return means tending to return them to their deployed position.

Preferably, the deflection means comprise at least two flaps mounted on either side of a midline of the door.

According to a first variant embodiment, the pivot shaft of at least one flap is situated close to a lateral end of the door.

Alternatively or additionally, the pivot shaft of at least one flap is situated in the vicinity of the midline of the door.

The disclosure also relates to a door thrust reverser characterized in that it comprises at least one door according to the invention and a fixed structure on which said door is mounted so as to pivot between a first position, called the closed position, in which it closes the reverser and forms a portion of an external cowl, the deflection means of the flow being in the retracted position, and a second position, called the open position, in which it exposes a passageway in the fixed structure and is capable of at least partially blocking an air flow generated by a turbojet, the deflection means being in the deployed position.

Advantageously, the fixed structure is fitted with abutment means capable of allowing a return of the deflection means to their retracted position when the door pivots to its closed position.

The disclosure also relates to a nacelle of a turbojet characterized in that it is fitted with at least one thrust-reverser system according to the invention.

### BRIEF DESCRIPTION OF THE DRAWINGS

The application of the invention will be better understood with the aid of the detailed description that is set out below with respect to the appended drawing in which:

FIGS. 1 and 2 are schematic representations in section of a door of a door thrust reverser according to the prior art in a respectively closed and open position.

FIG. 3 is a schematic representation in perspective of the inside of a door according to the invention in the open position.

FIG. 4 is a schematic representation from the front of the door of FIG. 3 showing a deflection flap in the deployed position.

FIG. 5 is a schematic representation from the front of the door of FIG. 3 showing a deflection flap in the retracted position.

FIGS. 6 and 7 are schematic representations in perspective from the front of a variant embodiment of said flap respectively in the retracted and deployed position.

FIGS. 8 and 9 are schematic representations in perspective from the side of a thrust-reversal structure fitted with a door as shown in FIGS. 6 and 7.

FIG. 10 is a schematic representation of the elastic return means fitted to the flap of a door according to the invention.

### DETAILED DESCRIPTION OF EMBODIMENTS OF THE INVENTION

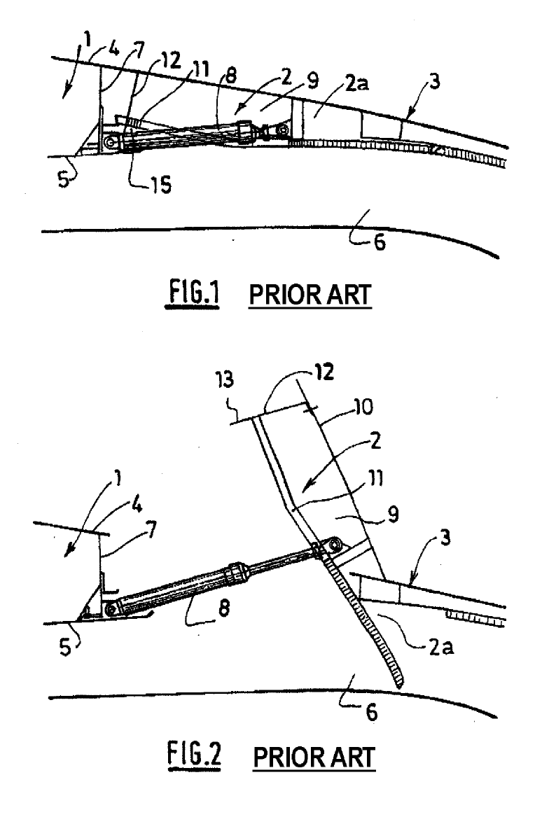

FIGS. 1 and 2 show a known exemplary embodiment of a door thrust reverser comprising doors fitted with a nonretractable deflection spoiler.

A thrust reverser of this type comprises three main parts, namely a fixed part 1, situated upstream in the extension of an external wall of an air-flow channel of the turbojet, a movable part 2, and a rear shroud 3, fixed.

The fixed part comprises a nacelle external panel 4 and an internal panel 5 forming an external panel of an air-flow duct 6.

The external panel 4 and internal panel 5 of the fixed part 1 are connected via a front frame 7 which also supports the means for controlling the movable part 2, in this instance formed by a cylinder 8.

The movable part 2 is made up of one or more movable elements commonly called doors 9.

Each door 9 is mounted pivotingly so as to be able, under the action of the control means 8, to tilt between a position in which it ensures the structural continuity between the fixed part 1 and the rear part 3 and of the inside of the duct 6 and an open position in which it exposes a passageway between the fixed part 1 and the rear part 3 allowing the air flow to escape through said opening.

As shown in FIG. 2, during this pivoting action, a rear part of the door 2a at least partly blocks the duct 6 thereby forcing the flow to travel through the exposed opening.

From a structural point of view, the door 9 comprises, on the one hand, an external panel 10 placed, in direct jet, in the extension of the external panel 4 of the fixed part and providing an external aerodynamic continuity with an external panel of the rear part 3, and on the other hand, an internal panel 11 and an upstream frame 12 connecting the external panel 10 and the internal panel 11.

The upstream frame 12 is extended by deflection means 13 designed, when the door 9 is open, to reorient a part of the air flow toward the front of the nacelle thereby generating a counter-thrust.

According to the prior art, these deflection means 13 are not retractable. Consequently, the total thickness of the door 9 at the front frame 7 of the fixed part 1, that is to say the total height of the upstream frame 12 to which is added the height of the deflection means 13, must not be greater than the height of the front frame 7 of the fixed part 1 at the risk of the deflection means 13 entering the inside of the duct 6 when the door 9 is in the closed position.

The result of this is that the height of the upstream frame 12 of the door 9 is less than the height of the front frame 7 of the fixed part 1 and that the internal wall 11 of the door is not at the same level as the internal wall 5 of the fixed part, thereby forming a cavity 15 forming an aerodynamic irregularity in the duct.

According to the invention, and as shown in FIGS. 3 to 9, the deflection means 13 are replaced by deflection means 16 mounted so as to pivot in the plane of the upstream frame 12 about a shaft 17.

It should be noted that FIGS. 3 to 9 each show a half-door as can be deduced from FIG. 3 in which the actuation means 8 is attached to the door 9 substantially in the middle of the latter. Those skilled in the art will complete by symmetry.

For reasons of sturdiness and of strength of the air-flow deflection means, the latter has an end, opposite from the shaft 17, that is mounted so as to slide in a guide rail 18 via a lug 19, said guide rail 18 moreover being secured to the upstream frame 12.

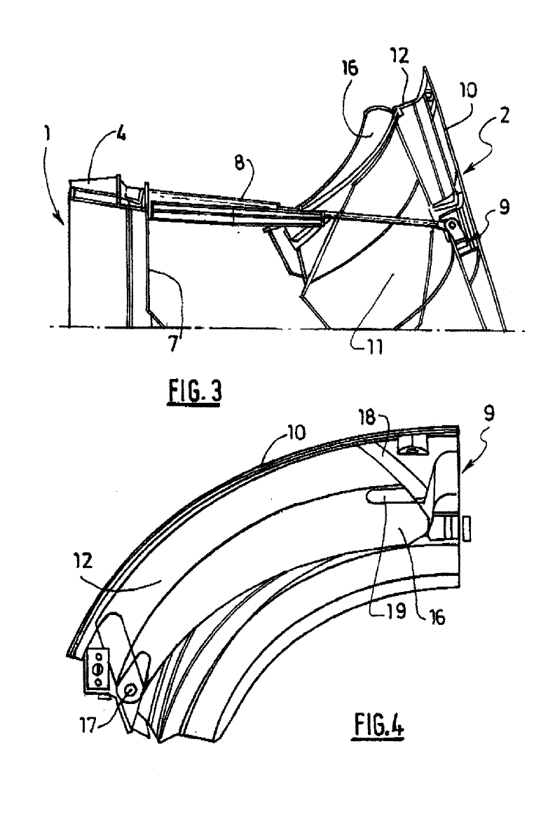

FIG. 4 shows such a deflection means 16 in the deployed position, a part of the deflection means 16 protruding from the door 9.

FIG. 5 shows the same deflection means 16 in the retracted position, no part of the deflection means 16 protruding from the door 9.

As explained above, FIGS. 4 and 5 each represent a half-door. In this instance, the deflection means 16 is mounted so as to pivot about a shaft 17 situated close to a lateral end of the door 9. Clearly, it is also possible to situate the shaft close to the midline of the door.

It will also be possible, amongst other things, to provide the following variants for the two deflection means 16 of the door 9 taken in its entirety:
a deflection means 16 associated with each of the half-parts of the door 9, the associated pivot shafts 17 each being mounted close to one side of the door,
a deflection means 16 associated with each of the half-parts of the door 9, the associated pivot shafts 17 being mounted one close to one side of the door, the other close to the midline of the door,
a deflection means 16 associated with each of the half-parts of the door 9, the associated pivot shafts 17 each being mounted close to a midline of the door.

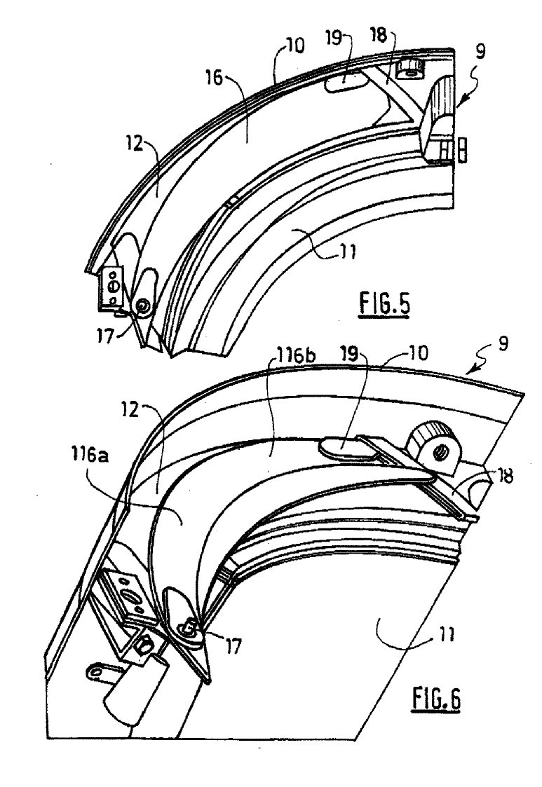

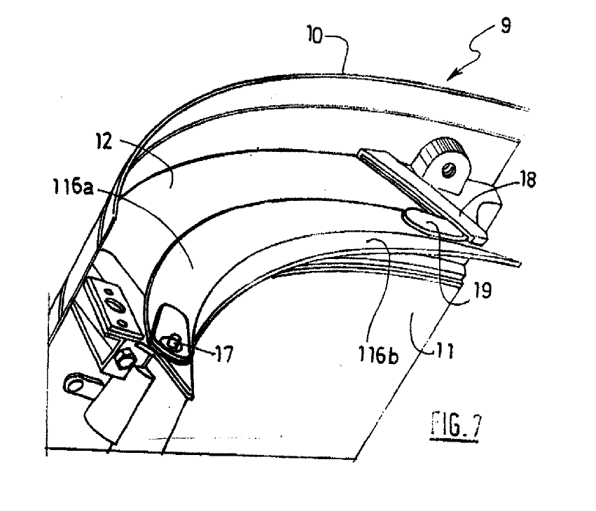

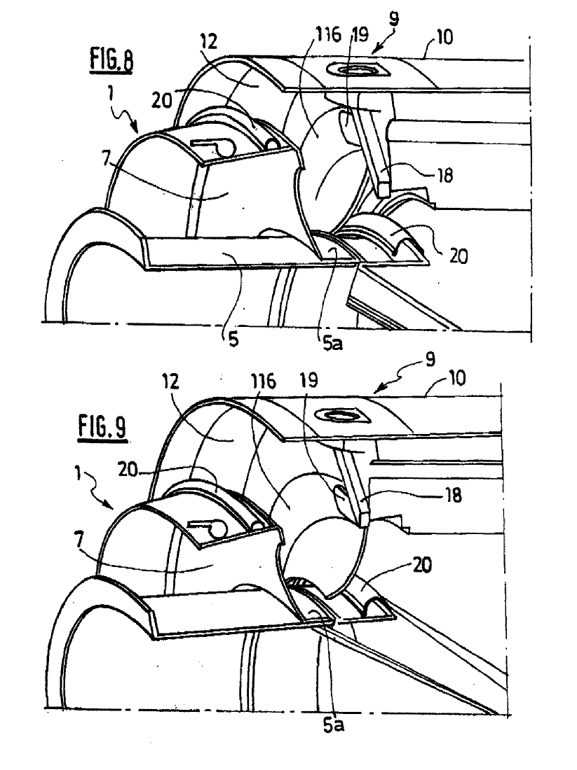

FIGS. 6 and 7 show variant embodiments of the deflection means 16 in the form of a flap 116. A flap 116 differs from a deflection means 16 by having a lower part 116b inclined relative to a flat upper part 116a, said lower part also having a certain curvature for the purpose of optimizing the reorientation of the inverted air flow.

FIGS. 8 and 9 show the door 9 in a situation relative to the fixed structure 1.

Note that the internal wall 5 of the fixed structure 1 has a slight extension 5a protruding from the front frame 7 and thereby forming an abutment means for the flap 116.

Therefore, when the door 9 is closed, as shown in FIG. 8, the flap 116 is forced against its elastic return means by the extension 5a.

When the door 9 is opened, the progressive separation of the door releases the flap 116 from the extension 5a which therefore no longer forms an abutment means and allows the automatic progressive deployment of the flap 116 under the action of the same elastic return means.

Note that the assembly is also fitted with closure seals 20 capable of ensuring that the structure is sealed when the door 9 is closed.

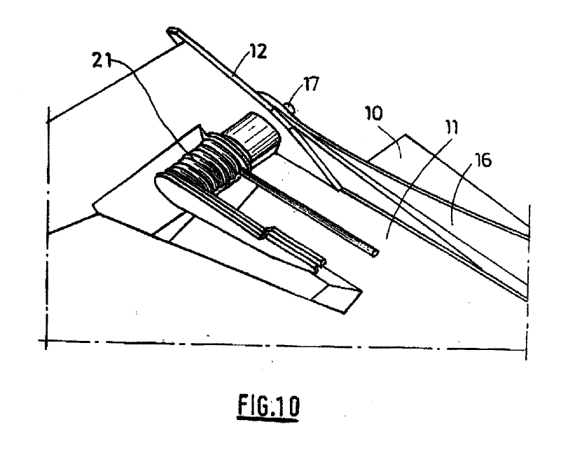

FIG. 10 shows the arrangement of the elastic return means associated with a deflection means 16.

The elastic return means is shown in the form of a spiral spring 21 mounted on the shaft 17 and housed in a recess of the internal surface 11 of the door 9.

Although the invention has been described with reference to particular exemplary embodiments, it is quite clear that it is in no way limited thereto and that it includes all the technical equivalents of the means described and their combinations if the latter form part of the invention.

1. A door for a door thrust reverser capable of being mounted so as to pivot on a fixed structure of a thrust reverser, comprising:
an internal surface designed to be incorporated into a flow duct for an air flow generated by a turbojet;
an external surface designed to ensure the external aerodynamic continuity of a nacelle designed to be fitted with said thrust reverser; and
air-flow deflection means placed on an upstream end of the door and mounted movably in a plane substantially perpendicular to a plane of the door between a first retracted position in which the deflection means do not enter the duct when the door is in a closed position and a second deployed position in which the deflection means protrude from the door;
wherein the deflection means are mounted rotatably in said plane about a corresponding shaft.

2. The door as claimed in claim 1, wherein the deflection means are mounted so that the means can move against elastic return means tending to return the means to the deployed position.

3. The door as claimed in claim 1, wherein the deflection means comprise at least two flaps mounted on either side of a midline of the door.

4. The door as claimed in claim 3, wherein a pivot shaft of at least one flap is situated close to a lateral end of the door.

5. The door as claimed in claim 4, wherein the pivot shaft of at least one flap is situated in a vicinity of the midline of the door.

6. A door thrust reverser, comprising:
at least one door as claimed in claim 1; and
a fixed structure on which said door is mounted so as to pivot between a first closed position, in which said door closes the reverser and forms a portion of an external cowl, the deflection means of the flow being in a retracted position, and a second open position, in which said door exposes a passageway in the fixed structure and is capable of at least partially blocking an air flow generated by a turbojet, the deflection means being in the deployed position.

7. The thrust reverser as claimed in claim 6, wherein the fixed structure is fitted with abutment means capable of allowing a return of the deflection means to their retracted position when the door pivots to the closed position.

8. A nacelle for a turbojet, comprising a thrust-reverser system as claimed in claim 6.

9. A nacelle for a turbojet, comprising a thrust-reverser system as claimed in claim 7.
